(19) United States
(12) Patent Application Publication
(10) Pub. No.: US 2012/0153629 A1
(43) Pub. Date: Jun. 21, 2012

(54) Undercurrent electric generator system

(76) Inventor: Baudilio Sanchez Sanchez, Pico Rivera, CA (US)

(21) Appl. No.: 12/928,695

(22) Filed: Dec. 17, 2010

(51) Int. Cl. F03B 13/00

(52) U.S. Cl. 290/54

(57) ABSTRACT

This invention discloses the efficient, non-polluting generation of electricity through the construction and use of an electric power generating system wherein electricity is generated by utilizing the powerful subsurface undercurrents present near an ocean shoreline. The undercurrent water is caused to cycle internally through a conical shell housing assembly constructed in an upwardly narrowing configuration to produce a nozzle effect within the shell housing. The nozzle effect generates a combined water and air power piston that alternates in a vertical direction within the shell assembly. In both the upward and downward cycles, the power piston impacts a fan blade component that causes the shaft of an electricity generating turbine to rotate and produce electricity.

### BACKGROUND OF THE INVENTION

There is considerable interest worldwide in finding an effective, efficient, and economical method of using the kinetic energy of the naturally-occurring movements of ocean water, including surface waves, tide water movements, and subsurface currents, to generate electrical power.

Subsurface currents are of particular interest as a potential energy source. These powerful water undercurrents ebb and flow approximately four times per minute near the ocean shoreline and constitute an abundant, clean, and renewable energy resource whose practical and applied use in generating electricity could have minimal negative environmental impact and substantial positive environmental impact.

The engineering challenge is to design an energy capture system that can generate electrical output from both the incoming current and the outgoing current and thereby operate with great energy efficiency. The energy capture system needs to withstand the corrosive seawater environment and, further, needs to accommodate fluctuations in the intensity and direction of the subsurface currents. The system should be simple in design and uncomplicated in operation, with minimal mechanical components involved in coupling the undercurrent motion to the turbine output.

### SUMMARY OF THE INVENTION

In the subject invention, ocean undercurrents and atmospheric airflow are redirected and focused by a conical shell housing to form a vertical fluid power piston that causes the combined energy of the ocean undercurrent and constrained airflow to drive, in alternating cooperative phases, a rotatable fan blade that is connected by a shaft to an electricity-generating turbine.

In the first phase of the power cycle, namely Power Cycle A, a conical shell housing captures incoming undercurrent water and, by means of its internal shape, causes the direction of the undercurrent water flow to change from a horizontal direction to an upward vertical direction. As the undercurrent water ascends in the conical shell housing, the internal walls of the shell housing cause the undercurrent water to flow from a substantially wider lower shell region into a narrower upper shell region. Consequently, the pressure exerted by the water increases as the volume within the shell housing decreases. The pressurized ascending water column causes the air above it in the upper shell chamber to forcefully exit the upper shell chamber through the shell top aperture, striking a rotatable fan blade component which is connected by a shaft to a turbine, causing the turbine rotor shaft to rotate and the turbine to generate electrical energy output.

In the second phase of the power cycle, namely Power Cycle B, a combination of gravity and suction created by the outgoing ocean undercurrent causes the water formation in the shell housing region to descend and flow out of the shell housing through the shell bottom aperture, thus vacating the shell upper chamber region. As a result, atmospheric pressure forces air into the shell upper chamber region through the shell upper aperture. The incoming air impacts a rotatable fan blade component, which causes the turbine rotor shaft to rotate and thus generates electricity. The resulting fluid movement creates a phased, synchronized, and alternating vertical fluid piston column that generates electrical energy in both Power Cycle A and cooperating Power Cycle B.

### Supplemental Embodiment

For those skilled in the art, the present invention is not limited to the subject matter components, and it is intended that all material contained herein and the accompanying drawings shall be interpreted as illustrative and not limiting.

Changes in details or structure may be made without departing from the spirit of the invention as defined in the appended claims and drawings of the invention.

### BRIEF DESCRIPTION OF THE DRAWINGS

The invention features will be better understood by reference to the following descriptions in conjunction with the accompanying drawings.

FIG. 1 is a schematic flow diagram of the assembly components of the subject invention.

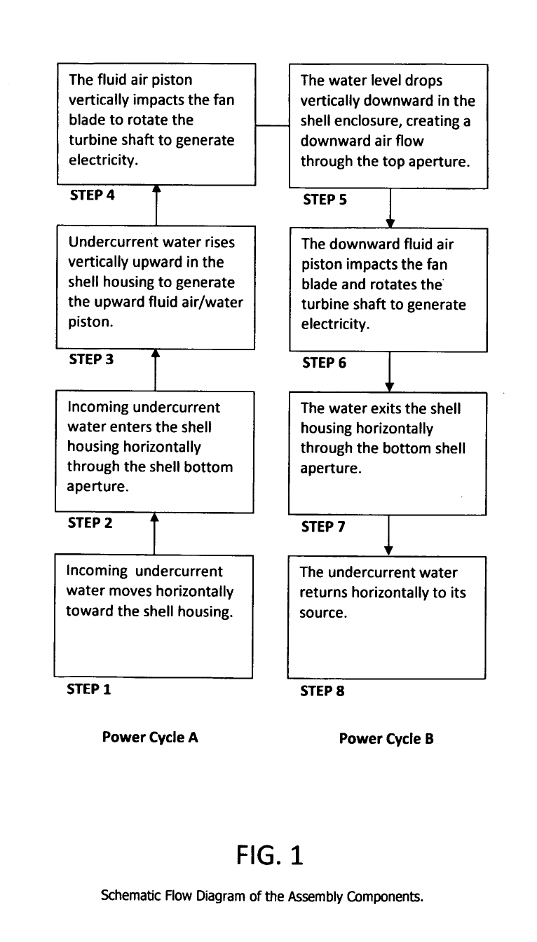

FIG. 2 is a cross-sectional view of the shell housing components for Power Cycle A.

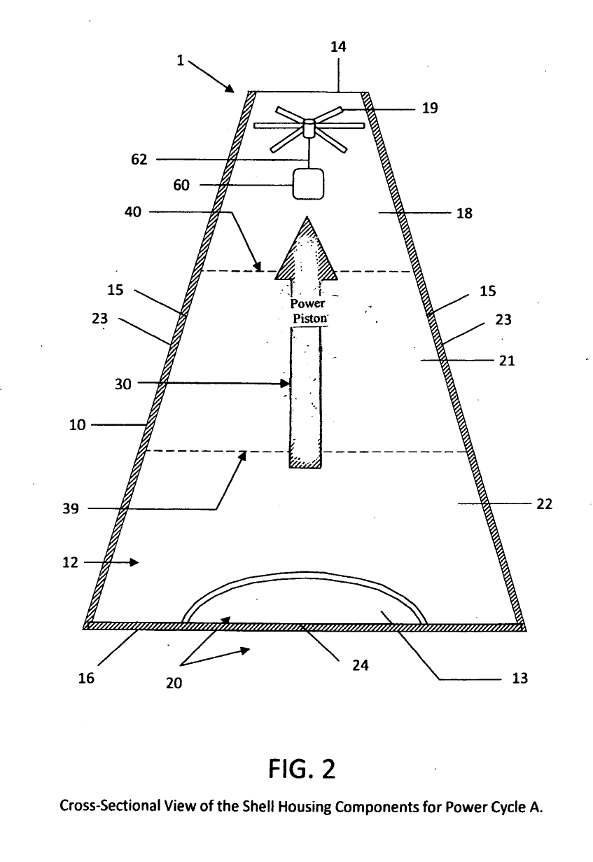

FIG. 3 is a cross-sectional view of the shell housing components for Power Cycle B.

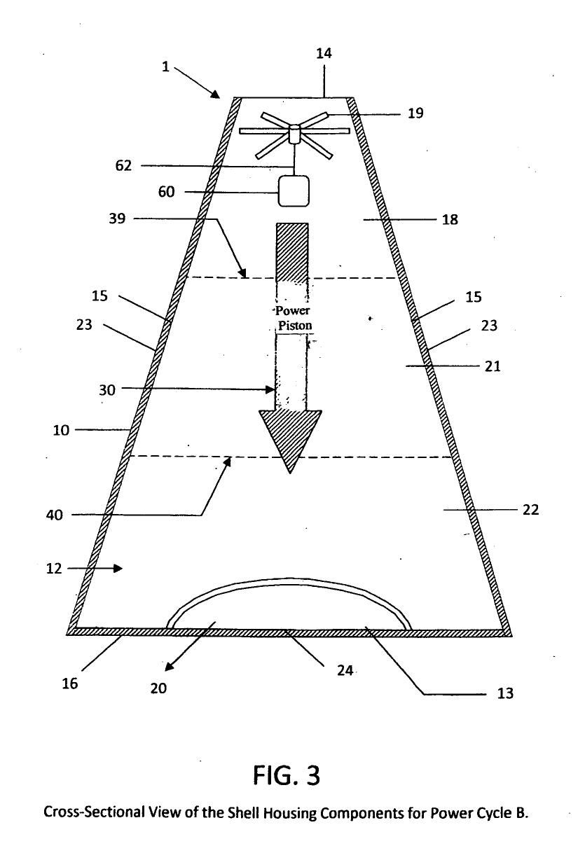

FIG. 4 is a diagrammatic view of Power Cycle A generating a vertical piston column in an upward direction.

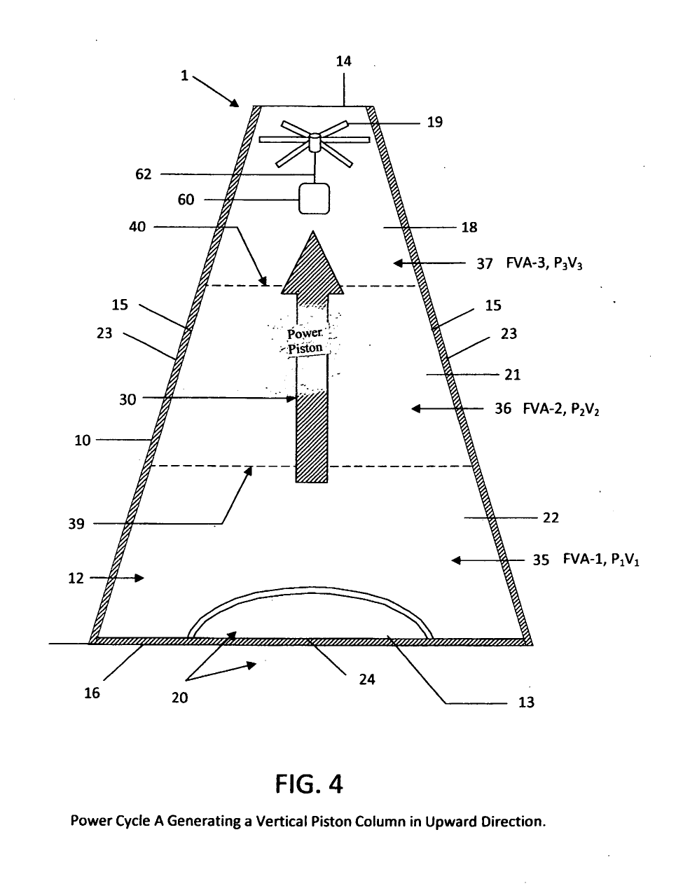

FIG. 5 is a diagrammatic view of Power Cycle B generating a vertical piston column in a downward direction.

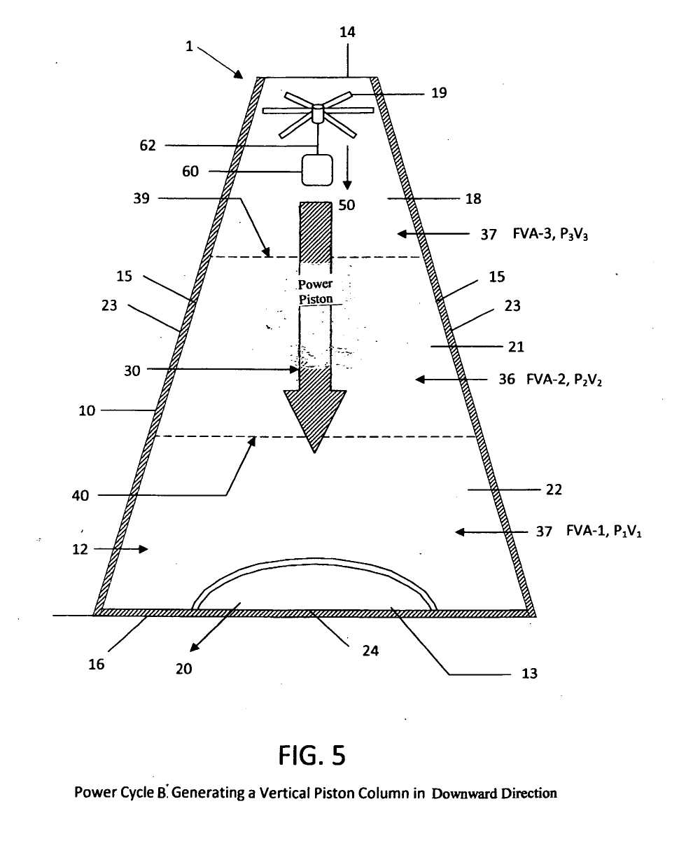

FIG. 6 is an external side view of the shell housing assembly.

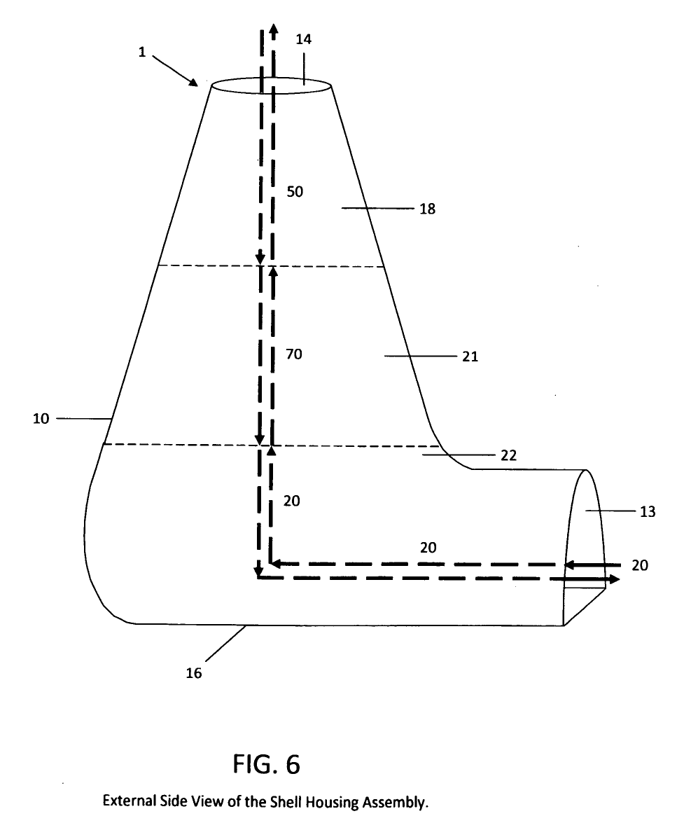

I claim:

1. An electrical energy-producing component system, operating with at least two power cycles that are synchronized, reversible, and repeatable, designated as Power Cycle A and reverse Power Cycle B, wherein the energy producing component system comprises:
a. a first system component being a conical hollow shell housing, wider at the base and narrower at the top to create a nozzle effect, constructed with an internal shell housing cavity, a base, and attendant cavity walls, mounted with a substantially vertical orientation;
b. a second system component being subsurface undercurrent water received from a naturally occurring oceanic undercurrent system;
c. a third system component being atmospheric air present in and around the shell housing prior to the entry of said second component into the shell housing;
d. said undercurrent water component is caused to ascend vertically by the conical shell housing interior side walls and is focused constructively within said shell housing cavity to generate a fluid piston within said cavity that is caused to impact the air component in the upper region of the cavity, thus generating a vertical air piston that impacts forcibly against the surface of a fourth system component, being a horizontal rotatable fan blade cooperatively mounted in said shell housing cavity upper region; and,
e. said system further containing a fifth component being a turbine having a turbine rotor shaft, capable of generating electric power when the turbine rotor shaft is rotated by the fourth system component, the rotatable fan blade.

2. The invention as claimed in claim 1; wherein said first component conical shell housing is constructed with a vertical orientation, and
a. said first shell housing component is divided into at least three fluid volumetric areas, namely Fluid Volumetric Area 1 (FVA-1), Fluid Volumetric Area 2 (FVA-2), and Fluid Volumetric Area 3 (FVA-3), within which the two complementary power cycles, Power Cycle A and Power Cycle B, function, said cooperating fluid volumetric areas being described, namely, as:
Power Cycle A Sequence:
FVA-1: bottom region
FVA-2: mid region
FVA-3: top region
Power Cycle B Sequence:
FVA-3: top region
FVA-2: mid region
FVA-1: bottom region
b. said conical shell housing is provided with at least one aperture in the bottom region of said shell housing component and is adapted to receive undercurrent water into said shell housing and discharge undercurrent water from said shell housing, wherein during system operation an air/water fluid power piston is generated within the confines of said shell housing cavity, the fluid piston being adapted to force said vertical piston to contact and transmit kinetic energy to said horizontal rotatable fan blade component;
c. said shell enclosure being internally constructed to create Power Cycle A, whereby an upward vertical fluid flow occurs in fluid volumetric areas FVA-1, FVA-2, and FVA-3; and Power Cycle B, whereby a downward reverse vertical fluid flow occurs in volumetric areas FVA-3, FVA-2, and FVA-1; and the fluid piston cycles through each shell region sequentially, first upward, then downward, progressively and sequentially, alternately decreasing and increasing their respective volumetric power areas;
d. during Power Cycle A, fluid compression and expansion in the volumetric power areas FVA-1, FVA-2 and FVA-3 create upward vector forces in said shell housing that drive said rotatable fan blade; during Power Cycle-B, compression and expansion in the volumetric power areas FVA-3, FVA-2 and FVA-1 create downward vector forces in the shell housing that drive said rotatable fan blade; in both power cycles, a fluid power piston is formed which drives the fan blade, causing the turbine to generate electricity;
e. said shell housing being provided with a fluid exit aperture located in the top upper exit region of said shell volumetric area FVA-3, for Power Cycle-A; for the Power Cycle-B, the fluid exit aperture is located at the bottom region of the shell, which is the volumetric area FVA-1;
f. wherein said second system component is from at least one oceanic undercurrent water source;
g. wherein said fourth system component is a rotatable fan blade mounted in a region near the top aperture region of said shell housing component, and is adapted to receive the vector forces derived from nozzle-induced air pressure generated from said vertical fluid piston column in FVA-3; and
h. wherein said fifth system component is an electrical turbine adapted to be rotated by a turbine rotor shaft connected to said rotatable fan blade located in said shell housing upper region.
